(19) United States
(12) Patent Application Publication
(10) Pub. No.: US 2026/0317611 A1
(43) Pub. Date: Oct. 15, 2026

(54) EFFICIENT AND ENVIRONMENTALLY FRIENDLY COOLANTS FOR DIRECT COOLING OF ELECTRIC ACCUMULATORS

(71) Applicant: OQ CHEMICALS GMBH, Monheim am Rhein (DE)

(72) Inventors: Claudia FISCHER, Ludwigshafen (DE); Jens KUBITSCHKE, Düsseldorf (DE); Alessa HINZMANN, Düsseldorf (DE)

(21) Appl. No.: 19/101,376

(22) PCT Filed: Jul. 31, 2023
(86) PCT No.: PCT/EP2023/071127

§ 371 Date: Feb. 5, 2025

(30) Foreign Application Priority Data
Aug. 8, 2022 (EP) 22189172.4

(51) Int. Cl. C09K 5/10; H01M 10/613; H01M 10/625; H01M 10/6567

(52) U.S. Cl. CPC C09K 5/10; H01M 10/613; H01M 10/625; H01M 10/6567

(57) ABSTRACT

The present invention relates to the use of a composition of greater than or equal to 80 wt. % and less than or equal to 100 wt. % consisting of diesters of butanediol with aliphatic C4-C10 monocarboxylic acids for direct temperature control of electric accumulators.

The present invention relates to the use of a composition of greater than or equal to 80 wt. % and less than or equal to 100 wt. % consisting of diesters of butanediol with aliphatic C4-C10 monocarboxylic acids for direct temperature control of electric accumulators.

The possibilities of the modern mobility society are based to a large extent on the use of powerful and safe energy storage devices, which form the basis for long-lasting and error-free functionality of the selected applications. For example, new functionalities of smartphones and tablets can only be successfully established on the market if the basic device is able to provide them reliably over a certain minimum period of use. This fundamental relationship applies even more to significantly more energy-intensive branches of application, such as electric mobility, whereby the different vehicle types can only successfully assert themselves against the existing alternatives on the market if they can provide practical ranges and charging times under a variety of environmental conditions. In particular, the development of efficient alkaline-ion energy storage in recent years has contributed to a significant increase in the maximum range of purely electric vehicles. However, a significant boost in development is still needed to offer not only a comparable but also a more environmentally friendly alternative to combustion engine-based locomotion concepts. To improve the efficiency of e-mobility, research and industry are essentially concentrating on increasing the performance of the batteries themselves. However, there is still great potential in optimising the integration of energy storage into the vehicle environment. For example, increasing the usable energy and the cycle count by providing controllable and consistent battery temperatures using active battery temperature control can help. In addition, it is of course desirable for this active temperature control to take place under the most environmentally friendly conditions possible. In particular, this may mean that the agents used for temperature control are not only efficient, but also non-toxic, non-polluting and biodegradable, and have a low GWP (global warming potential). This range of application and environmental requirements is currently not sufficiently met in the area of direct cooling or tempering fluids for batteries.

Patent literature also contains some examples of coolants being used for cooling electrical systems.

WO 2014 116 369 A1, for example, describes liquid cooling media used for immersion cooling of electronic hardware devices. Such liquid cooling media have a flash point of at least 190° C., determined according to ASTM D92, and a viscosity of 27 centistokes (‘cSt’) or less at 40° C., determined according to ASTM D445. Such liquid cooling media can be used to keep such devices as computer servers, server motherboards and microprocessors immersion cooled.

Furthermore, EP 2 520 637 A1 discloses a base oil for cooling a device, comprising: 30 mass % or more of at least one of an oleyl ester (an oleate and an oleyl alcohol ester) and an oleyl ether, the oleyl ester and the oleyl ether each having 23 or more of a total number of a terminal methyl group, a methylene group and an ether group in a main chain, the oleyl ester and the oleyl ether each having 1 or less of a total number of a methyl branch and an ethyl branch, and the base oil having a kinematic viscosity in the range of 4 mm²/s to 30 mm²/s.

JP 2011 063 734 A provides an electric motor oil composition with excellent electrical insulation, cooling performance and thermal oxidation stability, a high ignition point from a safety standpoint, lubricity and starting performance at low temperature, which composition is also usable as a gear oil and preferably has excellent biodegradability. The electric motor oil composition is prepared using a base oil comprising one or more types of esters having a hydroxyl value of ≤50 mg KOH/g, a total acid value of ≤2 mg KOH/g and an ignition point of ≥150° C., among esters synthesised from adipic acid and/or sebacic acid and a 5-14C alcohol and/or esters synthesised from neopentyl glycol and/or trimethylolpropane and a 5-14C carboxylic acid, and adding an amine compound and/or phenol compound to the base oil in an amount of 0.01-3.0 wt. %, based on the total composition.

Such solutions known from the prior art may still offer further potential for improvement, in particular with regard to the physical, biological and environmentally relevant properties of the tempering fluids in direct contact with batteries.

It is therefore the object of the present invention to overcome, at least in part, the disadvantages known from the prior art. In particular, the present invention is to provide a composition for use in temperature control of electrical accumulators like alkali-ion batteries, which has very good physical properties, such as low electrical conductivity, high heat capacity, excellent chemical stability and low viscosity and, in addition, very good biological properties, such as rapid biodegradability, low water hazard potential, low or no human toxicity and a low GWP.

The solution to the problem is achieved by the features of the independent claim, aimed at achieving the use according to the invention. Preferred embodiments of the invention are set out in the sub-claims, in the description or in the figures, whereby further features described or shown in the sub-claims or in the description or in the figures may individually or in any combination represent an object of the invention, unless the context clearly indicates otherwise.

The problem is solved according to the invention by using a composition of greater than or equal to 80 wt. % and less than or equal to 100 wt. % consisting of diesters of butanediol with aliphatic C4-C10 monocarboxylic acids for direct temperature control of electrical accumulators.

Surprisingly, it has been shown that compositions with a predominant proportion of esters of butanediol with medium-chain monocarboxylic acids are very well suited for direct cooling of electrical accumulators, for example in the form of alkali-ion batteries. The compositions show very good chemical compatibility with the housings of the batteries or the battery cells themselves and have a low viscosity over a wide temperature range, which has a positive effect on the energy required for active circulation of the cooling liquid. The particularly favourable viscosity properties of the compositions are evident at both higher and very low temperatures, which, together with low pour points, allows for a wide temperature range for the fluids. The compositions are also characterised by a suitably low electrical conductivity and high flash points. The compositions are non-toxic and, in particular, have a significantly lower GWP of 0 compared to other cooling media, such as CFCs. The proposed compositions are biodegradable, which, compared to other temperature control or cooling agents, leads to a significantly improved environmental balance when using the temperature control agents according to the invention. The compositions according to the invention, based on a small selection of aliphatic diesters of butanediol, are also chemically very stable, which ensures a long service life even under more extreme application conditions. Furthermore, the compositions are compatible to a large extent with the additives that can normally be used, so that further chemical and physical properties of the esters can be specifically modified via additives. This sum of positive properties of the compositions in the use according to the invention is particularly surprising, since, although suitable substance classes with a very large number of possible members have been proposed in the literature, the specifically disclosed members of these substance classes do not show such a balanced application profile in the claimed use. In this respect, it is surprising that a small group exists within the vast group of proposed compounds that is really significantly better suited for temperature control and in particular for cooling accumulators, for example in the form of alkali-ion batteries, and has balanced chemical, physical and biological application properties. Furthermore, the temperature control agents according to the invention can help to establish new accumulator-based electrical concepts on the market faster and more securely.

The composition according to the invention is used for direct temperature control of electrical accumulators. The composition according to the invention is in direct contact with the battery housing or the battery cells themselves and, via direct contact, regulates the temperature of the accumulators or batteries. In particular, accumulators are electrically rechargeable energy storage devices and, in theory, exhibit reversible chemical electrode processes during charging and discharging. Accordingly, controlling the temperature of the battery via an additional temperature exchange surface that is not in direct thermal contact with the battery housing or the batteries is not in accordance with the invention. Due to the fact that batteries usually heat up during operation, the composition essentially takes on the task of cooling the battery or battery array under application conditions. For example, normal operating temperatures can range from +80° C. to −40° C. The compositions according to the invention can be used to control the temperature of different battery types. In particular, accumulators that are based on the principle of the storage and retrieval of alkali ions or alkali metal or alkaline earth ions or alkaline earth metal in the anode or cathode can be favourably temperature-controlled. When using alkali ions as energy carriers, these batteries place certain demands on the temperature control medium with regard to the amounts of heat that usually need to be removed, which are fully met by the composition according to the invention. Even in the event of local overheating, direct cooling by the diesters according to the invention helps to slow it down. The alkali-ion batteries can have a wide variety of specific structures, for example, including the use of high-voltage electrodes. Due to the high dielectric strength of the temperature control fluid, high voltages can be handled safely even in the event of a failure of the battery structures. Examples of alkali-ion batteries are batteries that are based on the storage and retrieval of lithium, sodium, potassium or rubidium ions. Examples of alkaline earth ion batteries are batteries that are based on the storage and retrieval of Be, Mg or Ca ions.

The composition consists of greater than or equal to 80 wt. % and less than or equal to 100 wt. % of diesters of butanediol with aliphatic C4-C10 monocarboxylic acids. The composition thus consists largely or entirely of chemical compounds that belong to the group of esters. The esters are compounds of the dialcohol butanediol (C4O2H2), which is a dihydric aliphatic alcohol that can be present in the form of the different stereoisomers 1,2-butanediol, 1,3-butanediol, 1,4-butanediol, 2,3-butanediol or mixtures of at least two isomers from this list. The dihydric alcohol is esterified with one or two monocarboxylic acids with the elimination of water, where the monocarboxylic acids have 4 to 10 carbon atoms. The chains of the monocarboxylic acids are aliphatic chains, without unsaturated or aromatic portions. At least monoesters are formed, but in particular also fully (di)esters, whereby complete esterification is preferred but not mandatory for all butanediols used. The positive properties of using the butanediol esters are also particularly pronounced in compositions that contain a large proportion by weight of diesters. Significantly lower ester concentrations can be disadvantageous, since in this case the positive physical and chemical properties of the composition can no longer be maintained. However, small amounts of additives, such as corrosion inhibitors, viscosity-modifying additives, dyes or antioxidants, can be added in the specified range without extensive changes to the properties. The composition can also preferably comprise the esters according to the invention in amounts greater than or equal to 85 wt. % and less than or equal to 100 wt. %, furthermore preferably in amounts greater than or equal to 87.5 wt. % and less than or equal to 100 wt. %, and furthermore in amounts greater than or equal to 90 wt. % and less than or equal to 100 wt. %.

In a preferred embodiment of use, the butanediol may be a 1,3-butanediol. In its chemical and physical properties, in particular the 1,3-butanediol (1,3-BG) has been found to be particularly suitable for direct temperature control of batteries. In contrast to the other stereoisomers, the esters of 1,3-BG have particularly low pour points, particularly high flash points and good thermal properties. In addition, the viscosity profile of the 1,3-BG esters is particularly suitable, since low absolute viscosities and only a small viscosity increase as a function of a temperature reduction are obtained. In this respect, active circulation of the composition could be achieved with a low energy input due to the low viscosity, even at low temperatures.

In a further preferred embodiment of use, the monocarboxylic acids can be straight-chain monocarboxylic acids in a proportion of greater than or equal to 80 mol %. In particular, high proportions of unbranched, i.e. straight-chain monocarboxylic acids can be used for the esterification of the butanediol in order to obtain a particularly favourable viscosity profile, high flash points and very low pour points. These BG esters with straight-chain monocarboxylic acids can in particular have lower viscosities compared to esters from branched aliphatic monocarboxylic acids or esters of other diols. This circumstance is particularly advantageous in terms of energy in the case of forced convection of the tempering agent via pumps.

Within a further preferred aspect of use, the monocarboxylic acids can have an odd number of carbon atoms accounting for greater than or equal to 80 mol %. In particular, high proportions of monocarboxylic acids with an odd number of carbon atoms can be used for esterification with the butanediol in order to obtain high flash points and very low pour points. These BG esters from monocarboxylic acids with an odd number of carbon atoms can, in comparison to esters from monocarboxylic acids with an even number of carbon atoms, have physical properties that make the compositions safely manageable even under extreme application conditions.

According to a preferred characteristic of use, the monocarboxylic acids can be selected from the group consisting of C5 to C9 monocarboxylic acids. In particular, the middle range of carbon chain lengths of the monocarboxylic acids can lead to particularly favourable physical and chemical properties for an esterification with butanediol. The compositions are chemically very stable and exhibit a suitable viscosity profile at very low and very high temperatures. The compositions also have very low pour points and, at a sufficient degree of esterification, very low electrical conductivity. Preferably, the group of monocarboxylic acids can also be selected from C5 to C8 monocarboxylic acids or C5 to C7 monocarboxylic acids. Within these groups, very good and homogeneous physical and electrical properties are obtained.

In a further preferred embodiment of use, the monocarboxylic acids may be selected from the group consisting of C5 or C7 straight chain monocarboxylic acids or mixtures thereof. These esters of the BGs with an odd number of carbon atoms and a mid-chain carbon atom show particularly low viscosities, even in a very low temperature range. These compounds are biodegradable and non-toxic to humans.

Within a preferred aspect of use, the composition can consist of greater than or equal to 95 wt. % and less than or equal to 100 wt. % of diesters. In particular, a high degree of esterification of the compositions can improve the electrical and physical properties for the use according to the invention. Very low conductivities and a suitable viscosity profile can be ensured with high degrees of esterification. The degree of esterification can be determined, for example, spectroscopically or, preferably, chemically via the hydroxyl number.

In a further preferred embodiment of use, the monocarboxylic acids can consist of greater than or equal to 95 mol % of straight-chain C7 monocarboxylic acids. In particular, C7 esters and, in addition, C7 diesters of butanediol can lead to particularly favourable physical properties of the composition, including very good thermal and electrical properties. This also applies to a high degree to the diesters of 1,3-BG. The compositions are chemically very stable under application conditions and show good biodegradability. All in all, the result is very environmentally friendly tempering fluids that have a significantly better and more balanced property profile than the known alternatives.

In a further embodiment of use, the diester may be a diester of 1,3-butanediol, wherein 1,3-butanediol is esterified to greater than or equal to 95 mol % with straight-chain C7 monocarboxylic acids. The preferred chemical and physical properties of the composition arise in particular in those cases in which a very high degree of esterification is achieved in the esterification. This relationship arises in particular from the use of unbranched monocarboxylic acids. A diester can be a full ester of the BG, in particular of the 1,3-BG. However, it is also possible that the degree of esterification for the diester is greater than or equal to 96 mol %, is greater than or equal to 97.5 mol % and is greater than or equal to 99 mol % of the esterifiable alcohol groups. The degree of esterification can be determined by chemical methods known to those skilled in the art.

In a preferred embodiment of use, greater than or equal to 95 mol % of the monocarboxylic acids may consist of straight-chain C5 monocarboxylic acids. In particular, the C5 monocarboxylic acids as ester component can lead to diester compositions that exhibit a particularly favourable viscosity profile with a very small viscosity index, low pour points and high flash points.

In a further preferred embodiment of use, the diester may be a diester of 1,3-butanediol, wherein 1,3-butanediol is esterified to greater than or equal to 95 mol % with straight-chain C5 monocarboxylic acids. In particular, the monocarboxylic acids with a total number of carbon atoms in the mid carbon atom range show a very balanced viscosity profile with low pour points. The compositions of these diesters exhibit thermal properties and good chemical resistance even at very low and high temperatures.

Within a further preferred aspect of use, the content of diesters, based on the molar amount of alcohol and determined by GC, can be greater than or equal to 95 mol % and less than or equal to 100 mol %. In particular, very high contents of diesters of the BG can contribute to particularly suitable physical and chemical properties for use in the direct cooling of, for example, Li-ion batteries. Sufficient amounts of heat for cooling or for heating can be achieved by convection or by active circulation of the tempering liquid with low energy input. This can improve or increase the energy balance of the operation of the accumulators, the electrical performance and the cycle count under constant electrical power.

According to a preferred characteristic of use, the content of monoesters, based on the molar amount of alcohol, determined by GC, can be greater than or equal to 0 mol % and less than or equal to 2.5 mol %. A small proportion of monoesters in the compositions can help to improve the electrical properties of the compositions, for example with regard to the electrical conductivity of the compositions. This can result in compositions that have extremely low conductivity and are therefore significantly superior to the commonly used water/glycol mixtures in terms of electrical operational safety. The molar content of monoesters is obtained in relation to the sum of the monoesters and diesters present.

According to a preferred characteristic of use, the electrical accumulators may be Li-ion accumulators. For the electrical application profile of Li-ion batteries or accumulators, the compositions according to the invention have been found to be particularly suitable for cooling or temperature control. The temperature peaks that usually occur during power output and charging can be delayed and safely compensated. Overall, the electrical performance of the entire system can be improved as a result.

Within a preferred aspect of use, the Li-ion accumulators can be used to power vehicles. The compositions according to the invention can contribute in particular to an extension of the electrical performance of Li-ion accumulators, which are operated in vehicles. Even under changing environmental conditions and with strongly varying load and charging profiles, the waste heat that occurs can be safely dissipated. This applies to a high degree to the temperature control of large battery arrays, whereby the low electrical conductivity of the compositions according to the invention can also achieve a significantly improved safety profile in the event of an accident. Vehicles in the sense of the invention are partly or fully electrically driven means of transport, such as aeroplanes, bicycles, scooters, motorcycles, auto rickshaws, rail vehicles, passenger cars or vehicles for freight transport, mining or agriculture or forestry.

Within a further preferred aspect of use, the composition can be used simultaneously for cooling accumulators, for example in the form of alkali-ion batteries, and for lubricating moving parts within a vehicle. Due to the particularly favourable thermal and viscosity properties, the compositions according to the invention can be used not only for cooling but also for lubricating moving parts.

### EXAMPLES

### I Preparation of the Esters for Use According to the Invention

The esters according to the invention are represented by a reaction of the corresponding monocarboxylic acids with one or more stereoisomers of butanediol. In the reaction, for example, a molar ratio of monocarboxylic acids to alcohol of greater than or equal to 2.5 to 1 (monocarboxylic acid to dialcohol) can be selected. The reactions are carried out in the presence of a water entraining agent in the absence of a catalyst in a pressure range of 50 mbar up to normal pressure. The reaction times depend on the desired degree of esterification and can, for example, be greater than or equal to 5 hours.

### II Physical Properties of the Esters Compared to Esters not According to the Invention

In principle, different diols can be used for esterification with monocarboxylic acids. In the literature, in addition to other compounds, esters are also mentioned that are said to be suitable for use as coolants or lubricants. The following table shows the viscosities as a function of temperature, the pour points and the flash points of various diols that have been reacted with aliphatic C5 to C7 monocarboxylic acids:

| | | | | Flash | |
|---|---|---|---|---|---|
| | | | | point | Pour |
| | Viscosity in mm²/sec | | | in ° C. | point |
| Diester | 20° C. | 40° C. | 100° C. | (CC) | in ° C. |
| TCD DM-di-nC5-ester | 55.40 | 23.00 | 4.46 | — | −61 |
| NPG-di-nC5-ester | 5.94 | 3.60 | 1.38 | 154 | −89 |
| 1,3-BG-di-nC5-ester | 4.95 | 3.13 | 1.27 | 152 | −93 |
| TCD DM-di-nC7-ester | 69.30 | 28.20 | 5.24 | 190 | −61 |
| NPG-di-nC7-ester | 10.07 | 5.69 | 1.88 | 190 | −86 |
| 1,3-BG-di-nC7-ester | 8.35 | 4.88 | 1.73 | 191 | −95 |
| TCD DM-di-nC9-ester | 92.50 | 36.70 | 6.46 | 191 | −61 |
| NPG-di-nC9-ester | 16.45 | 8.62 | 2.57 | 203 | −33 |
| 1,3-BG-di-nC9-ester | 13.90 | 7.55 | 2.39 | 195 | −41 |

Tricyclodecane dimethanol diesters (TCD-DM) have high flash points and rather average pour points, but the viscosity of these esters at 20° C. is in an unfavourably high range above 50 mm²/sec at 20° C. The viscosities of TCD-DM diesters are the highest compared to neopentyl glycol diesters (NPG) and 1,3-butanediol esters. Neopentyl glycol diesters (NPG) have comparable flash points to 1,3-BG diesters, but both the pour points and the viscosities are lower for the 1,3-BG diesters. The difference in the viscosities of the NPG and 1,3-BG diesters is particularly visible in the temperature range ≤0° C. The following table shows the measured values, which demonstrate that the viscosities of the 1,3-BG diesters are much lower than those of the NPG diesters in the low-temperature range:

| | | | | | Thermal | Heat capacity |
|---|---|---|---|---|---|---|
| | | | | | conductivity | at 20° C. |
| | Viscosity in mm²/sec | | | | at 20° C. | [J/(g*K)] |
| Diester | −40° C. | −20° C. | −10° C. | 0° C. | [W/(m*K)] | ASTM E 1269 |
| NPG-di-nC5-ester | — | 30.0 | — | 11.5 | — | — |
| 1,3-BG-di-nC5-ester | 63.5 | 21.2 | 13.4 | 9.0 | 0.141 | 1.95 |
| NPG-di-nC7-ester | 302.0 | 66.0 | 39.0 | 23.0 | 0.12 | 1.897 |
| 1,3-BG-di-nC7-ester | 209.0 | 44.8 | 26.4 | 17.1 | 0.144 | 2.02 |

The diesters of 1,3-BG are characterised by adequate flash points, low pour points and very low, advantageous viscosities compared to other esters. In addition, the thermal properties, such as thermal conductivity determined according to ASTM D 7896, can be described as very good. For this reason, the 1,3-BG diesters are particularly suitable for use as tempering or cooling agents for direct cooling of electrical accumulators, such as, for example, alkali-ion batteries, in comparison with other esters.

### III Electrical Properties and Environmental Aspects of Esters According to the Invention

The electrical conductivity of full esters of the BGs with the monocarboxylic acids that can be used according to the invention is usually in the range of less than 10 nS/m, determined according to CEI 60247. The GWP of the compounds is in the range of 0. The compounds are biodegradable. For example, the degradability, determined according to Sturm, CO₂ release, OECD 301B, can be greater than 60% in 28 days. This results in a classification as readily biodegradable. The compounds are not toxic to humans.

### IV Physical Properties of Esters According to the Invention

The following data are obtained for the various 1,3-BG esters as a function of the monocarboxylic acid carbon atom chain length:

| | | | | | Flash | | Therm. | Heat capacity |
|---|---|---|---|---|---|---|---|---|
| | | | | | point | Pour | conductivity | at 20° C. |
| 1,3-BG | Viscosity (mm²/sec) | | | | (° C.) | point | at 20° C. | [J/(g*K)] |
| diester | −40° C. | 20° C. | 40° C. | 100° C. | CC | (° C.) | [W/(m*K)] | ASTM E 1269 |
| nC2 | | 3.21 | 2.01 | 0.827 | 97 | −79 | | |
| nC3 | | 2.94 | 1.93 | 0.85 | 110 | −83 | | |
| nC4 | | 4.02 | 2.59 | 1.09 | 132 | −95 | | |
| nC5 | 63.5 | 4.95 | 3.13 | 1.27 | 152 | −93 | 0.141 | 1.95 |
| nC7 | 209 | 8.35 | 4.88 | 1.73 | 191 | −95 | 0.144 | 2.02 |
| nC8/C10 | | 13.9 | 7.53 | 2.4 | 205 | −49 | | |
| nC9 | | 13.9 | 7.55 | 2.39 | 195 | −41 | | |
| nC12 | | 25.8 | 13 | 3.58 | 229 | −1 | | |

For safe use of a tempering or cooling agent in direct contact with battery cells, the compositions should have a high flash point, a low pour point and a low viscosity. As can be seen from the compilation of the various diesters as a function of the carbon atom chain length of the monocarboxylic acids used, diesters with a very small carbon atom chain length provide compositions with a flash point that is too low in the range of 110° C. Diesters of monocarboxylic acids with a very long chain length provide very high flash points, but these diesters have unsatisfactory pour points and a viscosity that is much too high.

In particular, diesters of 1,3-butanediol with monocarboxylic acids, which have an average carbon atom chain length, have very good properties for direct cooling of electrical accumulators, such as alkaline-ion batteries. The compositions have a very low viscosity, yet remarkably low pour points, high flash points and good thermal properties. These monocarboxylic acids with a carbon atom number of C4 to C10 and to a particularly high degree of C5 to C7 are therefore suitable for efficient cooling of, for example, lithium-ion batteries.

1. A composition of greater than or equal to 80 wt. % and less than or equal to 100 wt. % consisting of diesters of butanediol with aliphatic C4-C10 monocarboxylic acids for direct temperature control of electrical accumulators.

2. The composition according to claim 1, wherein the butanediol is 1,3-butanediol.

3. The composition according to claim 1, wherein greater than or equal to 80 mol % of the monocarboxylic acids are straight-chain monocarboxylic acids.

4. The composition according to claim 1, wherein greater than or equal to 80 mol % of the monocarboxylic acids have an uneven number of carbon atoms.

5. The composition according to claim 1, wherein the monocarboxylic acids are selected from the group consisting of C5 to C9 monocarboxylic acids.

6. The composition according to claim 1, wherein the monocarboxylic acids are selected from the group consisting of straight-chain C5 or C7 monocarboxylic acids or mixtures thereof.

7. The composition according to claim 1, wherein the composition consists of greater than or equal to 95 wt. % and less than or equal to 100 wt. % of diesters.

8. The composition according to claim 1, wherein the monocarboxylic acids consist of greater than or equal to 95 mol % of straight chain C7 monocarboxylic acids.

9. The composition according to claim 1, wherein the diester is a diester of 1,3-butanediol, wherein greater than or equal to 95 mol % of the 1,3-butanediol is esterified with straight-chain C7 monocarboxylic acids.

10. The composition according to claim 1, wherein greater than or equal to 95 mol % of the monocarboxylic acids consist of straight-chain C5 monocarboxylic acids.

11. The composition according to claim 10, wherein the diester is a diester of 1,3-butanediol, wherein 95 mol % or more of the 1,3-butanediol is esterified with straight-chain C5 monocarboxylic acids.

12. The composition according to claim 1, wherein the content of diesters, based on the molar amount of alcohol, determined by GC, is greater than or equal to 95 mol % and less than or equal to 100 mol %.

13. The composition according to claim 1, wherein the content of monoesters, based on the molar amount of alcohol, determined by GC, is greater than or equal to 0 mol % and less than or equal to 2.5 mol %.

14. The composition according to claim 1, wherein the electric accumulators are Li-ion accumulators.

15. The composition according to claim 14, wherein the Li-ion accumulators are used for powering vehicles.
